(19) United States
(12) Patent Application Publication
(10) Pub. No.: US 2025/0220683 A1
(43) Pub. Date: Jul. 3, 2025

(54) METHODS, DEVICES, AND MEDIUM FOR COMMUNICATION

(71) Applicant: NEC Corporation, Tokyo (JP)

(72) Inventors: Lin LIANG, Beijing (CN); Gang WANG, Beijing (CN)

(73) Assignee: NEC Corporation, Tokyo (JP)

(21) Appl. No.: 18/880,502

(22) PCT Filed: Jul. 8, 2022
(86) PCT No.: PCT/CN2022/104674

§ 371 Date: Dec. 31, 2024

(51) Int. Cl. H04W 72/231; H04L 1/00; H04W 72/12

(52) U.S. Cl. CPC H04W 72/231; H04L 1/0008; H04W 72/12

(57) ABSTRACT

Example embodiments of the present disclosure relate to methods, devices, and computer storage medium for communication. A terminal device performs a first size alignment of a pair of DCI formats for multi-cell scheduling if a total number of DCI sizes configured to monitor a PDCCH is greater than a predefined number after a plurality of size alignments of a plurality of pairs of DCI formats for single-cell scheduling; and monitors the PDCCH from a network device based on the first size alignment. As such, an order for DCI size alignments may be determined and the total number of DCI sizes may be limited. The DCI formats for multi-cell scheduling may be aligned after size alignments of DCI formats for signal-cell scheduling, thus the blind detection complexity may be reduced and the detection performance may be improved.

### FIELD

Example embodiments of the present disclosure generally relate to the field of communication techniques and in particular, to methods, devices, and a computer readable medium for communication.

### BACKGROUND

In 3rd generation partnership project (3GPP) TS 38.213, it is defined that a user equipment (UE) monitors a set of physical downlink control channel (PDCCH) candidates in one or more control resource sets (CORESETs) on the active downlink (DL) bandwidth part (BWP) on each activated serving cell configured with PDCCH monitoring according to corresponding search space sets where monitoring implies receiving each PDCCH candidate and decoding according to the monitored downlink control information (DCI) formats.

In release 15, a DCI on a PDCCH may be used to schedule a physical downlink shared channel (PDSCH) on a serving cell. In release 17, the DCI is enhanced to schedule multiple PDSCHs in different slots in time domain on the serving cell. It is proposed to further enhance DCI to schedule multiple PDSCHs on multiple cells. However, how to blind detect (BD) PDCCH candidates for multiple PDSCHs on multiple cells is needed to be discussed.

### SUMMARY

In general, example embodiments of the present disclosure provide methods, devices and a computer storage medium for communication.

In a first aspect, there is provided a method of communication. The method comprises: in accordance with a determination, at a terminal device, that a total number of downlink control information (DCI) sizes configured to monitor a physical downlink control channel (PDCCH) is greater than a predefined number after a plurality of size alignments of a plurality of pairs of DCI formats for single-cell scheduling, performing a first size alignment of a pair of DCI formats for multi-cell scheduling; and monitoring the PDCCH from a network device based on the first size alignment.

In a second aspect, there is provided a method of communication. The method comprises: in accordance with a determination, at a terminal device, that a first size of a downlink control information (DCI) format for a first cell is smaller than a second size of the DCI format for a second cell, performing a size alignment of the first size and the second size, the terminal device being configured to monitor the DCI format scheduling a plurality of cells comprising the first cell and the second cell; and monitoring a physical downlink control channel (PDCCH) carrying the DCI format from a network device based on the size alignment.

In a third aspect, there is provided a method of communication. The method comprises: in accordance with a determination, at a terminal device, that a plurality of cells are configured with a same value for determining a starting position of a plurality of physical downlink control channel (PDCCH) candidates, determining a first number of the plurality of cells and a second number of the plurality of PDCCH candidates; determining a number of PDCCH candidates for each of the plurality of cells based on the first number and the second number; and monitoring a PDCCH from a network device based on the number of PDCCH candidates for each cell.

In a fourth aspect, there is provided a method of communication. The method comprises: in accordance with a determination, at a network device, that a total number of downlink control information (DCI) sizes configured to monitor a physical downlink control channel (PDCCH) is greater than a predefined number after a plurality of size alignments of a plurality of pairs of DCI formats for single-cell scheduling, performing a first size alignment of a pair of DCI formats for multi-cell scheduling; and transmitting, to a terminal device, the PDCCH based on the first size alignment.

In a fifth aspect, there is provided a method of communication. The method comprises: in accordance with a determination, at a network device, that a first size of a downlink control information (DCI) format for a first cell is smaller than a second size of the DCI format for a second cell, performing a size alignment of the first size and the second size; and transmitting, to a terminal device, a physical downlink control channel (PDCCH) carrying the DCI format based on the size alignment, the terminal device being configured to monitor the DCI format scheduling a plurality of cells comprising the first cell and the second cell.

In a sixth aspect, there is provided a method of communication. The method comprises: in accordance with a determination, at a network device, that a plurality of cells are configured with a same value for determining a starting position of a plurality of physical downlink control channel (PDCCH) candidates, determining a first number of the plurality of cells and a second number of the plurality of PDCCH candidates; determining a number of PDCCH candidates for each of the plurality of cells based on the first number and the second number; and transmitting, to a terminal device, a PDCCH based on the number of PDCCH candidates for each cell.

In a seventh aspect, there is provided a terminal device. The terminal device comprises a processor and a memory. The memory is coupled to the processor and stores instructions thereon. The instructions, when executed by the processor, cause the terminal device to perform the method according to the first, second or third aspect above.

In an eighth aspect, there is provided a network device. The network device comprises a processor and a memory. The memory is coupled to the processor and stores instructions thereon. The instructions, when executed by the processor, cause the network device to perform the method according to the fourth, fifth or sixth aspect above.

In a ninth aspect, there is provided a computer readable medium having instructions stored thereon, the instructions, when executed on at least one processor, causing the at least one processor to carry out the method according to any of the first to the sixth aspects above.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication system in which some embodiments of the present disclosure can be implemented;

FIG. 2 illustrates a signalling chart illustrating communication process in accordance with some embodiments of the present disclosure;

FIG. 3 illustrates a signalling chart illustrating communication process in accordance with some embodiments of the present disclosure;

FIG. 4 illustrates a signalling chart illustrating communication process in accordance with some embodiments of the present disclosure;

FIG. 5 illustrates an example scenario in which some embodiments of the present disclosure may be implemented;

FIG. 6 illustrates a flowchart of an example method in accordance with some embodiments of the present disclosure;

FIG. 7 illustrates a flowchart of an example method in accordance with some embodiments of the present disclosure;

FIG. 8 illustrates a flowchart of an example method in accordance with some embodiments of the present disclosure;

FIG. 9 illustrates a flowchart of an example method in accordance with some embodiments of the present disclosure;

FIG. 10 illustrates a flowchart of an example method in accordance with some embodiments of the present disclosure;

FIG. 11 illustrates a flowchart of an example method in accordance with some embodiments of the present disclosure; and

FIG. 12 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The terminal device or the network device may have Artificial intelligence (AI) or machine learning capability. It generally includes a model which has been trained from numerous collected data for a specific function, and can be used to predict some information.

The terminal device or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network device under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, or channel emulator. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

In the context of the present disclose, the terms “acknowledgement”, “positive acknowledgement”, “ACK”, “HARQ”, “Hybrid automatic repeat request acknowledgement”, “HARQ-ACK”, “negative acknowledgement”, “NACK”, “NAK”, “ACK/NACK” and “ACK/NAK” can be used interchangeably. In the context of the present disclose, the terms “DCI”, “DCI format with information” and “DCI format” can be used interchangeably.

As stated above, to further improve scheduling efficiency, in release 18, one DCI is allowed to schedule multiple PDSCHs on multiple cells, where the multiple cells may also be called as multiple component carriers (CCs) in some scenarios. It is proposed that a fallback DCI, such as DCI formats 0_0 and 1_0, does not support multi-cell scheduling, and a DCI format 0-X or 1-X may be considered. In some examples, the DCI format 0-X/1-X on a scheduling cell can be used to schedule multiple physical uplink shared channels (PUSCHs) or PDSCHs on multiple cells including the scheduling cell. In some examples, the DCI format 0-X/1-X on a scheduling cell can be used to schedule multiple PUSCHs/PDSCHs on multiple cells not including the scheduling cell.

In the present disclosure, the term “multi-carrier DCI (MC-DCI)” may refer to one DCI scheduling for multiple carriers, one DCI scheduling for multiple cells, or the like. In the present disclosure, the term “slot” may refer to a dynamic scheduling unit. The slot used herein may refer to a normal slot which comprises a predetermined number of symbols, or may also refer to a sub-slot which comprises fewer symbols than the predetermined number of symbols.

Embodiments of the present disclosure provide a solution of communication. In the solution, the DCI formats for multi-cell scheduling may be aligned after size alignments of DCI formats for signal-cell scheduling. As such, the blind detection complexity may be reduced and the detection performance may be improved. Principles and implementations of the present disclosure will be described in detail below with reference to the figures.

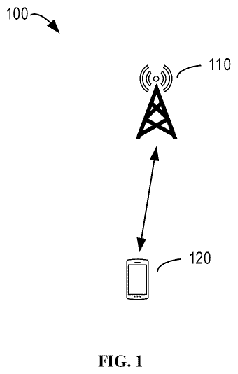

FIG. 1 illustrates an example communication system 100 in which some embodiments of the present disclosure can be implemented. The communication system 100, which is a part of a communication network, includes a network device 110 and a terminal device 120.

The network device 110 can provide services to the terminal device 120, and the network device 110 and the terminal device 120 may communicate data and control information with each other. In some embodiments, the network device 110 and the terminal device 120 may communicate with direct links/channels.

In the system 100, a link from the network devices 110 to the terminal device 120 is referred to as a downlink (DL), while a link from the terminal device 120 to the network devices 110 is referred to as an uplink (UL). In downlink, the network device 110 is a transmitting (TX) device (or a transmitter) and the terminal device 120 is a receiving (RX) device (or a receiver). In uplink, the terminal device 120 is a transmitting TX device (or a transmitter) and the network device 110 is a RX device (or a receiver). It is to be understood that the network device 110 may provide one or more serving cells. In some embodiments, the network device 110 can provide multiple cells.

The communications in the communication system 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the numbers of devices and their connection relationships and types shown in FIG. 1 are only for the purpose of illustration without suggesting any limitation. The communication system 100 may include any suitable numbers of devices adapted for implementing embodiments of the present disclosure.

In some embodiments, the network device 110 can provide multiple cells. In some embodiments, a DCI may be used for scheduling PDSCH(s). In some example embodiments, a DCI may be used for scheduling one or more PDSCHs on one serving cell. In some embodiments, a DCI may be used for scheduling multiple PDSCHs on multiple cells, where at least one PDSCH is scheduled for any one of the multiple cells.

In some embodiments, a UE may monitor a set of PDCCH candidates for obtaining the DCI. A PDCCH candidate may include three elements, i.e., a DCI size, a starting point and an aggregation level. To reduce PDCCH monitoring complexity, there is an upper bound restriction on the number of PDCCH candidates and the number of control-channel elements (CCEs). For example, the maximum number of monitored PDCCH candidates per slot and per serving cell may be represented as M_{PDCCH}^{max,slot,μ}. For example, the maximum number of non-overlapped CCEs per slot and per serving cell may be represented as C_{PDCCH}^{max,slot,μ}.

Additionally, there is DCI size restriction on “3+1” per serving cell, i.e. the total number of different DCI sizes configured to monitor is no more than 4 for the cell; and the total number of different DCI sizes with cell-Radio Network Temporary Identifier (C-RNTI) configured to monitor is no more than 3 for the cell. In some embodiments, when the total number of different DCI sizes is not fulfilled, DCI size alignment is adopted on some DCI formats to reduce the total number of different DCI sizes.

In some examples, as shown in Table 1, it is assumed that lengths for DCI formats 1_0/0_0 on common search space (CSS) and DCI formats 1_0/0_0 on UE-specific search space (USS) are A and B respectively, it is assumed that lengths for DCI format 0_1 and DCI format 1_1 are C and D respectively, and it is assumed that lengths for DCI format 0 2 and DCI format 1_2 are E and F respectively.

In some embodiments, there may be 3 steps for reducing the total number of different DCI sizes. Firstly, align formats 1_0/0_0 between CSS and USS; secondly, align formats 0_2 and 1_2; and thirdly, align format 0_1 and 1_1. As shown in Table 1, if the total number of DCI sizes is more than 3, the first step is performed and the lengths of 1_0/0_0 on CSS and 1_0/0_0 on USS is aligned to A. If the total number of DCI sizes is still more than 3 after the first step, the second step is performed and the length of 0_2 and 1_2 is aligned to max (E, F). If the total number of DCI sizes is still more than 3 after the second step, the third step is performed and the length of 0_1 and 1_1 is aligned to max (C, D).

TABLE 1

| DCI format | length | 1st | 2nd | 3rd |
|---|---|---|---|---|
| 1_0/0_0 on CSS | A | A | A | A |
| 1_0/0_0 on USS | B | A | A | A |
| 0_1 | C | C | C | max(C, D) |
| 1_1 | D | D | D | max(C, D) |
| 0_2 | E | E | max(E, F) | max(E, F) |
| 1_2 | F | F | max(E, F) | max(E, F) |

In some embodiments, the starting position of a PDCCH candidate may be determined. In some examples, for a search space set s associated with CORESET p, the CCE indexes for aggregation level L corresponding to PDCCH candidate m_{s,n}_{_{CI}}^{(L)} of the search space set in slot n_{s,f}^{μ} for an active DL BWP of a serving cell corresponding to carrier indicator field value n_{CI} are given by the following equation (1):

$$L \cdot \{ ( {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i \qquad ( 1 )$$

In equation (1), Y_{p,n}_{_{s,f}}_{^{μ}}=0 for any CSS and Y_{p,n}_{_{s,f}}_{^{μ}}=(Aₚ·Y_{p,n}_{_{s,f}}_{^{μ}}₋₁)mod D for a USS, where Y_{p,-1}=n_{RNTI}≠0, Aₚ=39827 for p mod 3=0, Aₚ=39829 for p mod 3=1, Aₚ=39839 for p mod 3=2, and D=65537.

In equation (1), i=0, . . . , L−1. N_{CCE,p} is the number of CCEs, numbered from 0 to N_{CCE,p}−1, in CORESET p and, if any, per RB set. n_{CI} is the carrier indicator field value if the UE is configured with a carrier indicator field by CrossCarrierSchedulingConfig for the serving cell on which PDCCH is monitored; otherwise, including for any CSS, n_{CI}=0.

In equation (1), m_{s,n}_{_{CI}}^{(L)}=0, . . . , M_{s,n}_{_{CI}}^{(L)}−1, where M_{s,n}_{_{CI}}^{(L)} is the number of PDCCH candidates the UE is configured to monitor for aggregation level L of a search space set s for a serving cell corresponding to n_{CI}.

In equation (1), M_{s,max}^{(L)}=M_{s,0}^{(L)} for any CSS, and for a USS, M_{s,max}^{(L)} is the maximum of M_{s,n}_{_{CI}}^{(L)} over all configured n_{CI} values for a CCE aggregation level L of search space set s. In equation (1), the RNTI value used for n_{RNTI} is the C-RNTI.

In some embodiments, the information element (IE) CrossCarrierSchedulingConfig is used to specify the configuration when the cross-carrier scheduling is used in a cell.

```
CrossCarrierSchedulingConfig ::= SEQUENCE {
  schedulingCellInfo CHOICE {
  own SEQUENCE {-- Cross carrier scheduling: scheduling cell
    cif-Presence BOOLEAN
  },
  other SEQUENCE {-- Cross carrier scheduling: scheduled cell
      schedulingCellId ServCellIndex,
      cif-InSchedulingCell INTEGER (1..7)
  }
  },
    ...
}
```

In some embodiments, the IE “schedulingCellId” indicates which cell signals the downlink allocations and uplink grants, if applicable, for the concerned SCell. In case the UE is configured with dual connectivity (DC), the scheduling cell is part of the same cell group (i.e. a master cell group (MCG) or a secondary cell group (SCG)) as the scheduled cell. In case the UE is configured with two PUCCH groups, the scheduling cell and the scheduled cell are within the same PUCCH group.

In some embodiments, DCI size budget may be further studied for multi-cell scheduling DCI. In some examples, an existing DCI size budget may be maintained per scheduled cell. For example, DCI size budget is maintained via DCI size alignment and DCI size budget of DCI format 0_X/1_X is counted for each of the co-scheduled cells. For example, DCI size budget is maintained via configured size for multi-cell scheduling DCI and DCI size budget of DCI format 0_X/1_X is counted for each of the co-scheduled cells. For example, DCI size budget is maintained via DCI size alignment and DCI size budget of multi-cell scheduling DCI is counted only in one scheduled cell.

In some other examples, the existing DCI size budget is not necessarily maintained per scheduled cell. For example, DCI size budget of multi-cell scheduling DCI is counted only in one scheduled cell. For example, DCI size budget of multi-cell scheduling DCI is not counted per serving cell and not considered in the related serving cell specific DCI size alignment procedure, e.g., for K co-scheduled cells, gNB guarantee the total budget of 3*K DCI sizes is not exceeded. For example, voiding the “3+1” limit for multi-cell scheduling. For example, the DCI size budget for DCI size alignment can be separately configured for each cell. For example, DCI size budget of the scheduling cell can be increased to account for the DCI format for multi-cell scheduling. Accordingly, the DCI size budget of a scheduled cell can be reduced.

In some embodiments, BD/CCE counting for multi-cell scheduling DCI may be further studied. In some examples, it may be counted on each co-scheduled cell. In some examples, it may be counted only in one scheduled cell. In some examples, it may be scaled down to each of co-scheduled cell according to the number of co-scheduled cells. In some examples, it may be counted as part of the scheduling cell instead of each scheduled cell. In some examples, it may be scaled down to each of scheduled cells excluding scheduling cell. In some examples, it may be counted on each co-scheduled cell excluding scheduling cell.

In some embodiments, for multi-cell scheduling, the co-scheduled cells are indicated by DCI format 0_X/1_X. In some examples, there may be one option of an indicator in the DCI points to one row of a table defining combinations of scheduled cells. For example, the table is configured by radio resource control (RRC) signaling. For example, separate tables can be configured for multi-cell PDSCH scheduling and multi-cell PUSCH scheduling. In some examples, there may be one option of an indicator in the DCI is a bitmap corresponding to a set of configured cells that can be scheduled by the DCI 0_X/1_X. For example, separate sets of configured cells for multi-cell PDSCH scheduling and multi-cell PUSCH scheduling. In some examples, there may be one option of using existing field (e.g., carrier indicator field (CIF), frequency domain resource assignment (FDRA)) to indicate whether one or more cells are scheduled or not. In some examples, it does not preclude other DCI information fields (e.g., BWP) to be jointly indicated by the indicator of the co-scheduled cells.

In the context of the present disclose, the term “DCI formats for multi-cell scheduling” may refer to a DCI format scheduling uplink transmission on multiple cells and a DCI format scheduling downlink transmission on multiple cells. In some examples, the DCI formats for multi-cell scheduling may comprise a DCI format 0_X and a DCI format 1_X.

In the context of present disclosure, the term “DCI formats for single cell scheduling” may also be called as DCI formats not for multi-cell scheduling. In some examples, the DCI formats for single cell scheduling may comprise DCI formats 0_2 and 1_2, DCI formats 0_1 and 1_1, DCI formats 1_0/0_1 on CSS and 1_0/0_1 on USS.

In case MC-DCI is configured, a DCI format 0_X/1_X may be used for configuring multiple PDSCHs/PUSCHs on multiple cells. According to embodiments of the present disclosure, there is provided a solution of DCI size alignment. In this solution, DCI formats for multi-cell scheduling may be aligned after size alignments of DCI formats for signal cell scheduling. As such, an order for size alignments may be determined and the total number of DCI sizes may be limited.

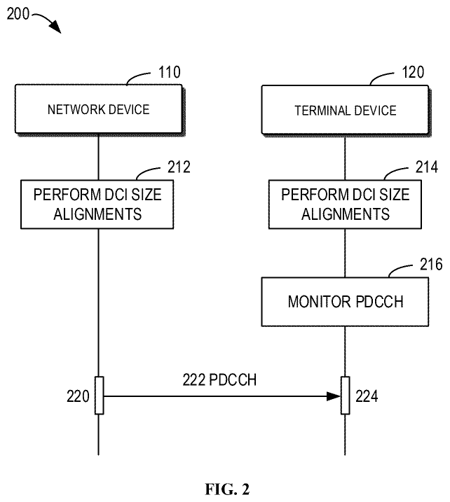

Reference is first made to FIG. 2, which illustrates a signalling chart illustrating communication process 200 in accordance with some example embodiments of the present disclosure. Only for the purpose of discussion, the process 200 will be described with reference to FIG. 1. The process 200 may involve the terminal device 120 and the network device 110.

In some example embodiments, the terminal device 120 may be configured with MC-DCI, that is, the terminal device 120 may be configured to receive a DCI scheduling to receive PDSCHs on multiple cells.

The network device 110 performs 212 DCI size alignments of different DCI formats. The network device 110 further transmits 220 PDCCH 222 to the terminal device 120. On the other side of communication, the terminal device 120 performs 214 DCI size alignments of different DCI formats. The terminal device 120 monitors 216 PDCCH from the network device 110 based on the DCI size alignments. The terminal device 120 may receive 224 the PDCCH 222 by monitoring.

In some example embodiments, the DCI size alignments performed by the terminal device 120 and/or the network device 110 as shown in FIG. 2 may be specific to a cell, a serving cell for example. In some example embodiments, the DCI size alignments performed by the terminal device 120 and/or the network device 110 may be based on a predefined number of a total number of DCI sizes. In some example embodiments, if the total number of DCI sizes configured to monitor PDCCH is more than 4 or the total number of DCI sizes with C-RNTI configured to monitor PDCCH is more than 3, the DCI size alignments may be further performed.

Specifically, if the total number of DCI sizes configured to monitor PDCCH is more than 4 after size alignments of DCI formats for signal-cell scheduling, or if the total number of DCI sizes with C-RNTI configured to monitor PDCCH is more than 3 after size alignments of DCI formats for signal-cell scheduling, a first size alignment of the DCI formats for multi-cell scheduling may be performed.

For example, if the total number of DCI sizes is greater than 4 after a size alignment of DCI formats 0_1 and 1_1 (step 3 as shown in Table 1) or if the total number of DCI sizes with C-RNTI is greater than 3 after a size alignment of DCI formats 0_1 and 1_1 (step 3 as shown in Table 1), the sizes of DCI format 0_X and the DCI format 1_X may be aligned.

In some examples, if the size of the DCI format 0_X is smaller than the size of the DCI format 1_X, a number of padding bits may be generated for the DCI format 0_X, and the DCI format 0_X may be padded to the size of the DCI format 1_X. In some examples, if the size of the DCI format 1_X is smaller than the size of the DCI format 0_X, a number of padding bits may be generated for the DCI format 1_X, and the DCI format 1_X may be padded to the size of the DCI format 0_X

In some example embodiments, if the total number of different DCI sizes configured to monitor is more than 4 for the cell after DCI alignment of format 0_2/1_2 and 0_1/1_1, or if the total number of different DCI sizes with C-RNTI configured to monitor is more than 3 for the cell after DCI alignment of format 0_2/1_2 and 0_1/1_1; then (1)-If the number of information bits in the DCI format 0_X prior to padding is less than the payload size of the DCI format 1_X for scheduling the same serving cell, a number of zero padding bits are generated for the DCI format 0_X until the payload size equals that of the DCI format 1_X; or (2)—If the number of information bits in the DCI format 1_X prior to padding is less than the payload size of the DCI format 0_X for scheduling the same serving cell, zeros shall be appended to the DCI format 1_X until the payload size equals that of the DCI format 0_X.

In some example embodiments, the DCI format 0_X/1_X needs larger number of information bits, thus the difference of number of information bits between formats 0_X and 1_X is larger which means more padding bits are needed for alignment. Padding bits will reduce the detection performance but can reduce blind detection complexity. Let format 0_X and 1_X alignment after format 0_1 and 1_1 alignment (the third step) can lead to the less possible of padding bits which would increase detection performance and reduce PDCCH CCE occupation. As such, the size alignment of DCI formats 0_X and 1_X may be performed at the fourth step.

As an example, it is assumed that lengths for the DCI format 0_X and the DCI format 1_X are G and H respectively. In some embodiments, if the total number of DCI sizes with C-RNTI is more than 3 after the third step of size alignment, a fourth step may be performed and the length of DCI formats 0_X and 1_X is aligned to max (G, H), as shown in Table 2 below.

In some example embodiments, if the total number of DCI sizes configured to monitor PDCCH is more than 4 after size alignments of DCI formats for multi-cell scheduling, or if the total number of DCI sizes with C-RNTI configured to monitor PDCCH is more than 3 after size alignments of DCI formats for multi-cell scheduling, the network device 110 and/or the terminal device 120 may determine that the size alignments are failed.

In some example embodiments, if the total number of DCI sizes configured to monitor PDCCH is more than 4 after size alignments of DCI formats for multi-cell scheduling, or if the total number of DCI sizes with C-RNTI configured to monitor PDCCH is more than 3 after size alignments of DCI formats for multi-cell scheduling, a second size alignment of the DCI formats between one of the DCI formats for single-cell scheduling and the DCI formats for multi-cell scheduling may be performed.

It is assumed that the sizes of the DCI formats for multi-cell scheduling have been aligned to a first size, and the size of one of the DCI formats for single-cell scheduling is a second size. In some examples, if the first size is smaller than the second size, then a number of padding bits may be generated for padding the DCI formats for multi-cell scheduling to be with the second size. In some examples, if the second size is smaller than the first size, then a number of padding bits may be generated for padding the one of the DCI formats for single-cell scheduling to be with the first size. In other words, the DCI formats for multi-cell scheduling (i.e., the DCI formats 0_X and 1_X) and one of the DCI formats for single-cell scheduling may be size aligned to a larger one of the first size and the second size.

In some examples, one of the DCI formats for single-cell scheduling to be aligned with the DCI formats for multi-cell scheduling may be a DCI format 0_1/1_1 or a DCI format 0_2/1_2. In some example embodiments, if the total number of different DCI sizes configured to monitor is more than 4 for the cell after DCI alignment of format 0_2/1_2, 0_1/1_1 and 0_X/1_X, or if the total number of different DCI sizes with C-RNTI configured to monitor is more than 3 for the cell after DCI alignment of format 0_2/1_2, 0_1/1_1 and 0_X/1_X; then (1)-If the number of information bits in the DCI format 0_1/1_1 prior to padding is less than the payload size of the DCI format 0_X/1_X for scheduling the same serving cell, a number of zero padding bits are generated for the DCI format 0_1/1_1 until the payload size equals that of the DCI format 0_X/1_X; or (2)-If the number of information bits in the DCI format 0_X/1_X prior to padding is less than the payload size of the DCI format 0_1/1_1 for scheduling the same serving cell, zeros shall be appended to the DCI format 0_X/1_X until the payload size equals that of the DCI format 0_1/1_1.

In some example embodiments, the one of DCI formats for single-cell scheduling may be a DCI format 0_1 or 1_1. In this way, the size of DCI formats 0_X and 1_X and the size of the DCI format 0_1/1_1 may be aligned. In some examples, DCI format 0_2/1_2 is mainly for compact DCI scheduling, adding padding bits on DCI format 0_2/1_2 will reduce detection performance significantly. Thus, to align DCI format 0_1/1_1 and 0_X/1_X can allow URLLC (ultra-reliable & low-latency communication) service transmission simultaneous with eMBB (Enhanced Mobile Broadband) service.

As an example, it is assumed that the size of DCI format 0_1/1_1 is max (C, D) after the third step, and the size of DCI format 0_X/1_X is max (G, H) after the fourth step. In some embodiments, if the total number of DCI sizes with C-RNTI is more than 3 after the fourth step of size alignment, a fifth step may be performed and the length of DCI formats 0_X/1_X and 0_1/1_1 is aligned to max (C, D, G, H), as shown in Table 2 below. It is understood that Table 2 shown below is only for illustration without limitation, the DCI formats 0_0/1_0 and the first and second steps are omitted in Table 2 for brief, which can refer to Table 1 shown above.

TABLE 2

| DCI format | length | 3rd | 4th | 5th |
|---|---|---|---|---|
| 0_1 | C | max(C, D) | max(C, D) | max(C, D, G, H) |
| 1_1 | D | max(C, D) | max(C, D) | max(C, D, G, H) |
| 0_2 | E | max(E, F) | max(E, F) | max(E, F) |
| 1_2 | F | max(E, F) | max(E, F) | max(E, F) |
| 0_X | G | G | max(G, H) | max(C, D, G, H) |
| 1_X | H | H | max(G, H) | max(C, D, G, H) |

As such, an order for DCI size alignments may be determined and the total number of DCI sizes may be limited. Specifically, DCI formats for multi-cell scheduling may be aligned after size alignments of DCI formats for signal-cell scheduling, thus the blind detection complexity may be reduced and the detection performance may be improved.

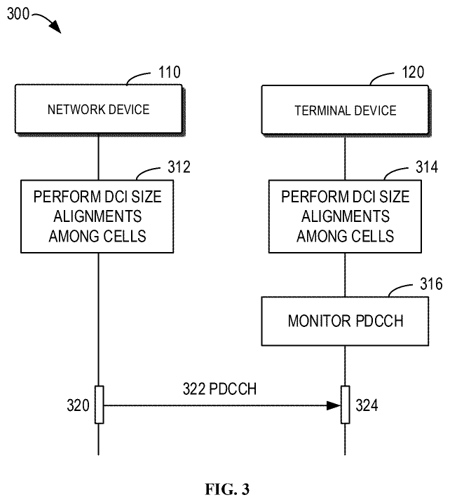

Reference is first made to FIG. 3, which illustrates a signalling chart illustrating communication process 300 in accordance with some example embodiments of the present disclosure. Only for the purpose of discussion, the process 300 will be described with reference to FIG. 1. The process 300 may involve the terminal device 120 and the network device 110. In some example embodiments, the terminal device 120 may be configured with MC-DCI, that is, the terminal device 120 may be configured to receive a DCI scheduling to receive PDSCHs on multiple cells.

The network device 110 performs 312 DCI size alignments among different cells. The network device 110 further transmits 320 PDCCH 322 to the terminal device 120. On the other side of communication, the terminal device 120 performs 314 DCI size alignments among different cells. The terminal device 120 monitors 316 PDCCH from the network device 110 based on the DCI size alignments. The terminal device 120 may receive 324 the PDCCH 322 by monitoring.

In some example embodiments, the DCI size alignments performed by the terminal device 120 and/or the network device 110 as shown in FIG. 3 may be among multiple cells including a first cell and a second cell. In some examples, the first cell may be a serving cell and the second cell may be another serving cell. In some example embodiments, a size of DCI format 0_X/1_X for the first cell may be smaller or greater than a size of DCI format 0_X/1_X for the second cell, and the size alignment of DCI format 0_X/1_X among different cells may be performed.

In some example embodiments, the network device 110 may transmit configuration information to the terminal device 120, and the configuration information may indicate whether to perform the size alignment among different cells. On the other side of communication, the terminal device 120 may receive the configuration information. In some examples, if the configuration information indicates to perform the size alignment among different cells, then the process 300 may be performed.

In some example embodiments, if a first size of the DCI format 0_X/1_X for the first cell is smaller than a second size of the DCI format 0_X/1_X for the second cell, a number of padding bits may be generated for padding the first size to be the second size. Similarly, if the second size of the DCI format 0_X/1_X for the second cell is smaller than the first size of the DCI format 0_X/1_X for the first cell, a number of padding bits may be generated for padding the second size to be the first size.

In some example embodiments, if the number of information bits in the DCI format 0_X or 1_X for a serving cell prior to padding is less than the payload size of the DCI format 0_X or 1_X for another serving cell, a number of zero padding bits are generated for the DCI format 0_X or 1_X until the payload size equals that of the DCI format 0_X or 1_X for another serving.

In some example embodiments, a same value may be configured for both the first cell and the second cell, and the save value is used for determining a starting position of PDCCH candidates. In some examples, the same value may be a carrier indicator field value, which is represented as n_{CI}. In some examples, for a specific serving cell, according to the starting position of PDCCH candidates determined based on n_{CI} configured for the serving cell, a search space may be determined accordingly.

As stated above, the DCI format 0_X/1_X is used to schedule PDSCHs on multiple cells. In some examples, each of the multiple cells may have a value to determine the PDCCH candidate starting position. In some examples, the value (such as n_{CI}) for different cells may be the same for DCI format 0_X/1_X.

It is understood that legacy carrier indicator field has two functions, i.e., to determine the scheduling cell and to determine PDCCH candidate starting position. However, in the present disclosure, the value can be used to determine PDCCH candidate starting position. In some examples, the value for determining the PDCCH candidate starting position may be an existing parameter or may be a new defined parameter. In some examples, there may be another value for determining the associated scheduling cell and the present disclosure does not limit this aspect.

As such, the DCI format 0_X/1_X among different cells may be aligned, and some benefits may be achieved. For example, when the PDCCH candidate of DCI format 0_X/1_X determined for the first cell is the same as the PDCCH candidate of DCI format 0_X/1_X determined for the second cell, then the size alignment of DCI format 0_X/1_X between the first cell and the second cell can reduce blind detection complexity.

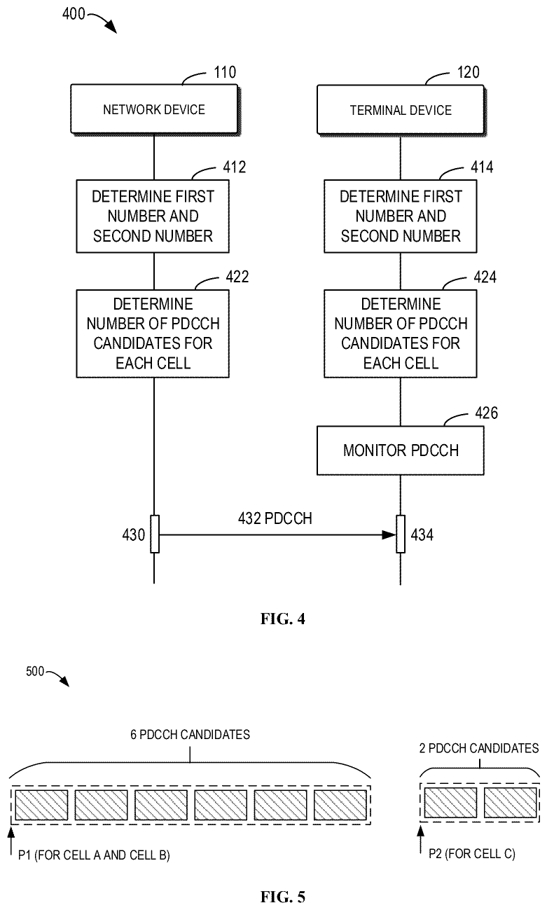

Reference is first made to FIG. 4, which illustrates a signalling chart illustrating communication process 400 in accordance with some example embodiments of the present disclosure. Only for the purpose of discussion, the process 400 will be described with reference to FIG. 1. The process 400 may involve the terminal device 120 and the network device 110.

In some example embodiments, the terminal device 120 may be configured with MC-DCI, that is, the terminal device 120 may be configured to receive a DCI scheduling to receive PDSCHs on multiple cells. In some example embodiments, two or more cells may be configured with a same value for determining a starting position of multiple PDCCH candidates.

The network device 110 determines 412 a first number of cells with a same number for determining a starting position of multiple PDCCH candidates and a second number of the multiple PDCCH candidates. The network device 110 determines 422 a number of PDCCH candidates for each of the two or more cells based on the first number and the second number. And the network device 110 further transmits 430 PDCCH 432 to the terminal device 120.

On the other side of communication, the terminal device 120 determines 414 a first number of cells with a same number for determining a starting position of multiple PDCCH candidates and a second number of the multiple PDCCH candidates. The terminal device 120 determines 424 a number of PDCCH candidates for each of the two or more cells based on the first number and the second number. The terminal device 120 monitors 426 PDCCH from the network device 110. And the terminal device 120 may receive 434 the PDCCH 432 by monitoring.

In some example embodiments, the value for determining the starting position may be configured by the network device 110, for example, via an RRC signal. In some examples, the value may be implemented as a carrier indicator field value (such as n_{CI}). For example, the network device 110 may configure (via an RRC signal) a carrier indicator field value n_{CI} to determine the PDCCH candidate starting position in each cell among multiple cells for DCI format 1-X/0-X, thus a list of n_{CI} values may be used to determine the starting position for blind detecting the DCI format 1-X/0-X.

In some example embodiments, the network device 110 and/or the terminal device 120 may determine that the number of PDCCH candidates for each cell is the second number divided by the first number. Alternatively or in addition, the network device 110 and/or the terminal device 120 may determine that the number of CCEs for each cell is a third number of CCEs determined by the value divided by the first number.

Specifically, if search space configurations on different cells have the same carrier indicator field value n_{CI} to determine the PDCCH candidate starting position, then the same aggregation level (AL) and number of candidates per AL is expected. In some examples, if there are N cells configured with the same carrier indicator field value n_{CI} to determine the PDCCH candidate starting position, the number of PDCCH candidates and CCEs per cell is equal to the number of PDCCH candidates and CCEs per n_{CI} divided by N, respectively.

For better understanding, reference is now made to FIG. 5 illustrating an example scenario 500 in which some embodiments of the present disclosure may be implemented. It is assumed that a DCI is used for scheduling multiple cells, including cell A, cell B and cell C. Cell A and cell B are configured with a same value n_{CI} (value 1), and cell C is configured with another value n_{CI} (value 2).

As shown in FIG. 5, the number of PDCCH candidates is 6 and the starting position is P1, based on value 1. In addition, the counting number of PDCCH candidates for cell A (or cell B) can be determined as 3, which equals to 6 divided by 2.

As shown in FIG. 5, the number of PDCCH candidates is 2 and the starting position is P2, based on value 2, which is specific to cell C. In this way, the network device 110 may have a flexibility on PDCCH candidates planning to configure a same or different n_{CI}. For example, for multiple cells with a same n_{CI}, more PDCCH candidates per AL may be configured since the multiple cells share the CCE counting for a same n_{CI}. As such, a block probability for DCI scheduling may be reduced at the network device 110 even with a configuration of more PDCCH candidates.

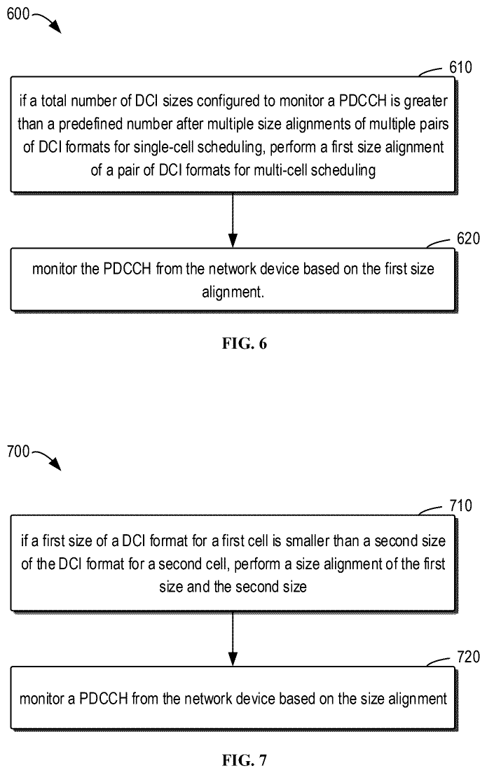

FIG. 6 illustrates a flowchart of an example method 600 implemented at a terminal device in accordance with some embodiments of the present disclosure. For the purpose of discussion, the method 600 will be described from the perspective of the terminal device 120 with reference to FIG. 1.

At block 610, if a total number of DCI sizes configured to monitor a PDCCH is greater than a predefined number after multiple size alignments of multiple pairs of DCI formats for single-cell scheduling, the terminal device 120 performs a first size alignment of a pair of DCI formats for multi-cell scheduling. At block 620, the terminal device 120 monitors the PDCCH from the network device 110 based on the first size alignment.

In some example embodiments, the pair of DCI formats comprises a first DCI format and a second DCI format. And the terminal device 120 determines, from the first DCI format and the second DCI format, one DCI format with a smaller size, where the first DCI format is used for scheduling uplink transmissions on multiple cells and the second DCI format is used for scheduling downlink transmissions on the multiple cells. The terminal device 120 may generate a number of padding bits for padding the one DCI format to be with a same size as the other one of the first DCI format and the second DCI format.

In some example embodiments, the terminal device 120 may further perform a second size alignment between the pair of DCI formats and one of the multiple pairs of DCI formats if a total number of DCI sizes configured to monitor the PDCCH is greater than the predefined number after the first size alignment.

In some example embodiments, if a first size of the pair of DCI formats is smaller than a second size of the one of the multiple pairs of DCI formats, the terminal device 120 may generate a number of padding bits for padding the pair of DCI formats to be with the second size. In some example embodiments, if a first size of the pair of DCI formats is greater than a second size of the one of the multiple pairs of DCI formats, the terminal device 120 may generate a number of padding bits for padding the one of the multiple pairs of DCI formats to be with the first size.

In some example embodiments, the one of the multiple pairs of DCI formats comprises DCI formats 0_1 and 1_1. In some example embodiments, the pair of DCI formats comprises DCI formats 0_X and 1_X

In some example embodiments, the total number of DCI sizes configured to monitor a PDCCH is greater than 4, or the total number of DCI sizes with a cell-radio network temporary identifier (C-RNTI) configured to monitor a PDCCH is greater than 3.

FIG. 7 illustrates a flowchart of an example method 700 implemented at a terminal device in accordance with some embodiments of the present disclosure. For the purpose of discussion, the method 700 will be described from the perspective of the terminal device 120 with reference to FIG. 1.

At block 710, if a first size of a DCI format for a first cell is smaller than a second size of the DCI format for a second cell, the terminal device 120 performs a size alignment of the first size and the second size, the terminal device 120 is configured to monitor the DCI format scheduling multiple cells comprising the first cell and the second cell. At block 720, the terminal device 120 monitors a PDCCH from the network device 110 based on the size alignment.

In some example embodiments, the terminal device 120 generates a number of padding bits for padding the first size to be the second size. In some example embodiments, the terminal device 120 further receives, from the network device 110, configuration information indicating whether to perform the size alignment among the multiple cells. In some example embodiments, the DCI format is a DCI format 0_X or a DCI format 1_X. In some example embodiments, the first cell and the second cell are configured with a same value for determining a starting position of multiple PDCCH candidates.

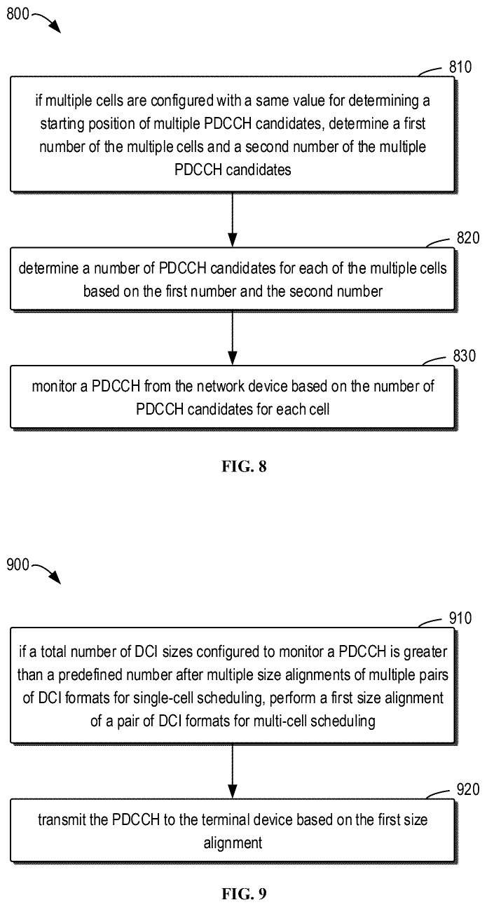

FIG. 8 illustrates a flowchart of an example method 800 implemented at a terminal device in accordance with some embodiments of the present disclosure. For the purpose of discussion, the method 800 will be described from the perspective of the terminal device 120 with reference to FIG. 1.

At block 810, if multiple cells are configured with a same value for determining a starting position of multiple PDCCH candidates, the terminal device 120 determines a first number of the multiple cells and a second number of the multiple PDCCH candidates. At block 820, the terminal device 120 determines a number of PDCCH candidates for each of the multiple cells based on the first number and the second number. At block 830, the terminal device 120 monitors a PDCCH from the network device 110 based on the number of PDCCH candidates for each cell.

In some example embodiments, the terminal device 120 determines the number of PDCCH candidates for each cell being the second number divided by the first number. In some example embodiments, the terminal device 120 further determines a number of CCEs for each cell being a third number of CCEs determined based on the value divided by the first number. In some example embodiments, the value is a carrier indicator field value.

FIG. 9 illustrates a flowchart of an example method 900 implemented at a network device in accordance with some embodiments of the present disclosure. For the purpose of discussion, the method 900 will be described from the perspective of the network device 110 with reference to FIG. 1.

At block 910, if a total number of DCI sizes configured to monitor a PDCCH is greater than a predefined number after multiple size alignments of multiple pairs of DCI formats for single-cell scheduling, the network device 110 performs a first size alignment of a pair of DCI formats for multi-cell scheduling. At block 920, the network device 110 transmits the PDCCH to the terminal device 120 based on the first size alignment.

In some example embodiments, the pair of DCI formats comprises a first DCI format and a second DCI format. And the network device 110 determines, from the first DCI format and the second DCI format, one DCI format with a smaller size, where the first DCI format is used for scheduling uplink transmissions on multiple cells and the second DCI format is used for scheduling downlink transmissions on the multiple cells. The network device 110 may generate a number of padding bits for padding the one DCI format to be with a same size as the other one of the first DCI format and the second DCI format.

In some example embodiments, the network device 110 may further perform a second size alignment between the pair of DCI formats and one of the multiple pairs of DCI formats if a total number of DCI sizes configured to monitor the PDCCH is greater than the predefined number after the first size alignment.

In some example embodiments, if a first size of the pair of DCI formats is smaller than a second size of the one of the multiple pairs of DCI formats, the network device 110 may generate a number of padding bits for padding the pair of DCI formats to be with the second size. In some example embodiments, if a first size of the pair of DCI formats is greater than a second size of the one of the multiple pairs of DCI formats, the network device 110 may generate a number of padding bits for padding the one of the multiple pairs of DCI formats to be with the first size.

In some example embodiments, the one of the multiple pairs of DCI formats comprises DCI formats 0_1 and 1_1. In some example embodiments, the pair of DCI formats comprises DCI formats 0_X and 1_X. In some example embodiments, the total number of DCI sizes configured to monitor a PDCCH is greater than 4, or the total number of DCI sizes with a cell-radio network temporary identifier (C-RNTI) configured to monitor a PDCCH is greater than 3.

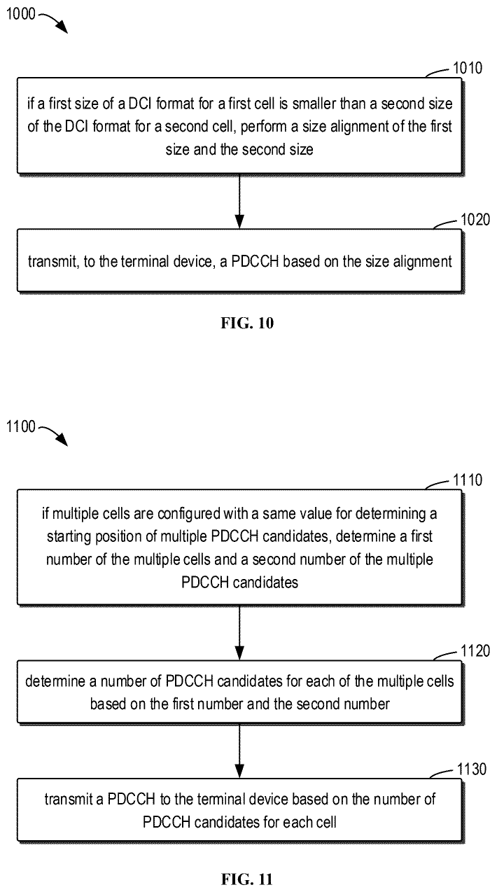

FIG. 10 illustrates a flowchart of an example method 1000 implemented at a network device in accordance with some embodiments of the present disclosure. For the purpose of discussion, the method 1000 will be described from the perspective of the network device 110 with reference to FIG. 1.

At block 1010, if a first size of a DCI format for a first cell is smaller than a second size of the DCI format for a second cell, the network device 110 performs a size alignment of the first size and the second size. At block 1020, the network device 110 transmits, to the terminal device 120, a PDCCH based on the size alignment, the terminal device 120 is configured to monitor the DCI format scheduling multiple cells comprising the first cell and the second cell.

In some example embodiments, the network device 110 generates a number of padding bits for padding the first size to be the second size. In some example embodiments, the network device 110 further transmits, to the terminal device 120, configuration information indicating whether to perform the size alignment among the multiple cells.

In some example embodiments, the DCI format is a DCI format 0_X or a DCI format 1_X. In some embodiments, the transmitted PDCCH may carry the DCI format for multi-cell scheduling. In some example embodiments, the first cell and the second cell are configured with a same value for determining a starting position of multiple PDCCH candidates.

FIG. 11 illustrates a flowchart of an example method 1100 implemented at a network device in accordance with some embodiments of the present disclosure. For the purpose of discussion, the method 1100 will be described from the perspective of the network device 110 with reference to FIG. 1.

At block 1110, if multiple cells are configured with a same value for determining a starting position of multiple PDCCH candidates, the network device 110 determines a first number of the multiple cells and a second number of the multiple PDCCH candidates. At block 1120, the network device 110 determines a number of PDCCH candidates for each of the multiple cells based on the first number and the second number. At block 1130, the network device 110 transmits a PDCCH to the terminal device 120 based on the number of PDCCH candidates for each cell.

In some example embodiments, the network device 110 determines the number of PDCCH candidates for each cell being the second number divided by the first number. In some example embodiments, the network device 110 further determines a number of CCEs for each cell being a third number of CCEs determined based on the value divided by the first number. In some example embodiments, the value is a carrier indicator field value.

Details of some embodiments according to the present disclosure have been described with reference to FIGS. 1-11. Now an example implementation of the terminal device and the network device will be discussed below.

In some example embodiments, a terminal device comprises circuitry configured to: if a total number of DCI sizes configured to monitor a PDCCH is greater than a predefined number after multiple size alignments of multiple pairs of DCI formats for single-cell scheduling, perform a first size alignment of a pair of DCI formats for multi-cell scheduling; and monitor the PDCCH from the network device based on the first size alignment.

In some example embodiments, the pair of DCI formats comprises a first DCI format and a second DCI format, the terminal device comprises circuitry configured to: determine, from the first DCI format and the second DCI format, one DCI format with a smaller size, where the first DCI format is used for scheduling uplink transmissions on multiple cells and the second DCI format is used for scheduling downlink transmissions on the multiple cells; and generate a number of padding bits for padding the one DCI format to be with a same size as the other one of the first DCI format and the second DCI format.

In some example embodiments, the terminal device comprises circuitry configured to: perform a second size alignment between the pair of DCI formats and one of the multiple pairs of DCI formats if a total number of DCI sizes configured to monitor the PDCCH is greater than the predefined number after the first size alignment.

In some example embodiments, if a first size of the pair of DCI formats is smaller than a second size of the one of the multiple pairs of DCI formats, the terminal device comprises circuitry configured to: generate a number of padding bits for padding the pair of DCI formats to be with the second size. In some example embodiments, if a first size of the pair of DCI formats is greater than a second size of the one of the multiple pairs of DCI formats, the terminal device comprises circuitry configured to: generate a number of padding bits for padding the one of the multiple pairs of DCI formats to be with the first size.

In some example embodiments, the one of the multiple pairs of DCI formats comprises DCI formats 0_1 and 1_1. In some example embodiments, the pair of DCI formats comprises DCI formats 0_X and 1_X.

In some example embodiments, the total number of DCI sizes configured to monitor a PDCCH is greater than 4, or the total number of DCI sizes with a cell-radio network temporary identifier (C-RNTI) configured to monitor a PDCCH is greater than 3.

In some example embodiments, a terminal device comprises circuitry configured to: if a first size of a DCI format for a first cell is smaller than a second size of the DCI format for a second cell, perform a size alignment of the first size and the second size, the terminal device is configured to monitor the DCI format scheduling multiple cells comprising the first cell and the second cell; and monitor a PDCCH carrying the DCI format from the network device based on the size alignment.

In some example embodiments, the terminal device comprises circuitry configured to: generate a number of padding bits for padding the first size to be the second size.

In some example embodiments, the terminal device comprises circuitry configured to: receive, from the network device, configuration information indicating whether to perform the size alignment among the multiple cells.

In some example embodiments, the DCI format is a DCI format 0_X or a DCI format 1_X.

In some example embodiments, a terminal device comprises circuitry configured to: if multiple cells are configured with a same value for determining a starting position of multiple PDCCH candidates, determine a first number of the multiple cells and a second number of the multiple PDCCH candidates; determine a number of PDCCH candidates for each of the multiple cells based on the first number and the second number; and monitor a PDCCH from the network device based on the number of PDCCH candidates for each cell.

In some example embodiments, the terminal device comprises circuitry configured to: determine the number of PDCCH candidates for each cell being the second number divided by the first number.

In some example embodiments, the terminal device comprises circuitry configured to: determine a number of CCEs for each cell being a third number of CCEs determined based on the value divided by the first number.

In some example embodiments, the value is a carrier indicator field value.

In some example embodiments, a network device comprises circuitry configured to: if a total number of DCI sizes configured to monitor a PDCCH is greater than a predefined number after multiple size alignments of multiple pairs of DCI formats for single-cell scheduling, perform a first size alignment of a pair of DCI formats for multi-cell scheduling; and transmit the PDCCH to the terminal device based on the first size alignment.

In some example embodiments, the pair of DCI formats comprises a first DCI format and a second DCI format, the network device comprises circuitry configured to: determine, from the first DCI format and the second DCI format, one DCI format with a smaller size, where the first DCI format is used for scheduling uplink transmissions on multiple cells and the second DCI format is used for scheduling downlink transmissions on the multiple cells; and generate a number of padding bits for padding the one DCI format to be with a same size as the other one of the first DCI format and the second DCI format.

In some example embodiments, the network device comprises circuitry configured to: perform a second size alignment between the pair of DCI formats and one of the multiple pairs of DCI formats if a total number of DCI sizes configured to monitor the PDCCH is greater than the predefined number after the first size alignment.

In some example embodiments, if a first size of the pair of DCI formats is smaller than a second size of the one of the multiple pairs of DCI formats, the network device comprises circuitry configured to: generate a number of padding bits for padding the pair of DCI formats to be with the second size. In some example embodiments, if a first size of the pair of DCI formats is greater than a second size of the one of the multiple pairs of DCI formats, the network device comprises circuitry configured to: generate a number of padding bits for padding the one of the multiple pairs of DCI formats to be with the first size.

In some example embodiments, the one of the multiple pairs of DCI formats comprises DCI formats 0_1 and 1_1. In some example embodiments, the pair of DCI formats comprises DCI formats 0_X and 1_X.

In some example embodiments, the total number of DCI sizes configured to monitor a PDCCH is greater than 4, or the total number of DCI sizes with a cell-radio network temporary identifier (C-RNTI) configured to monitor a PDCCH is greater than 3.

In some example embodiments, a network device comprises circuitry configured to: if a first size of a DCI format for a first cell is smaller than a second size of the DCI format for a second cell, perform a size alignment of the first size and the second size; transmit, to the terminal device, a PDCCH carrying the DCI format based on the size alignment, the terminal device is configured to monitor the DCI format scheduling multiple cells comprising the first cell and the second cell.

In some example embodiments, the network device comprises circuitry configured to: generate a number of padding bits for padding the first size to be the second size.

In some example embodiments, the network device comprises circuitry configured to: transmit, to the terminal device, configuration information indicating whether to perform the size alignment among the multiple cells.

In some example embodiments, the DCI format is a DCI format 0_X or a DCI format 1_X.

In some example embodiments, a network device comprises circuitry configured to: if multiple cells are configured with a same value for determining a starting position of multiple PDCCH candidates, determine a first number of the multiple cells and a second number of the multiple PDCCH candidates; determine a number of PDCCH candidates for each of the multiple cells based on the first number and the second number; and transmit a PDCCH to the terminal device based on the number of PDCCH candidates for each cell.

In some example embodiments, the network device comprises circuitry configured to: determine the number of PDCCH candidates for each cell being the second number divided by the first number.

In some example embodiments, the network device comprises circuitry configured to: determine a number of CCEs for each cell being a third number of CCEs determined based on the value divided by the first number.

In some example embodiments, the value is a carrier indicator field value.

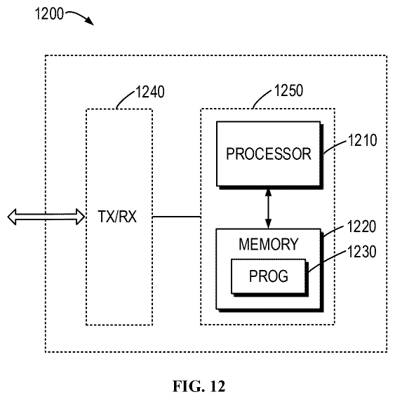

FIG. 12 illustrates a simplified block diagram of a device 1200 that is suitable for implementing embodiments of the present disclosure. The device 1200 can be considered as a further example implementation of the terminal device 120 and/or the network device 110 as shown in FIG. 1. Accordingly, the device 1200 can be implemented at or as at least a part of the terminal device 120 or the network device 110.

As shown, the device 1200 includes a processor 1210, a memory 1220 coupled to the processor 1210, a suitable transmitter (TX) and receiver (RX) 1240 coupled to the processor 1210, and a communication interface coupled to the TX/RX 1240. The memory 1210 stores at least a part of a program 1230. The TX/RX 1240 is for bidirectional communications. The TX/RX 1240 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1230 is assumed to include program instructions that, when executed by the associated processor 1210, enable the device 1200 to operate in accordance with the embodiments of the present disclosure, as discussed herein with reference to FIGS. 2-11. The embodiments herein may be implemented by computer software executable by the processor 1210 of the device 1200, or by hardware, or by a combination of software and hardware. The processor 1210 may be configured to implement various embodiments of the present disclosure. Furthermore, a combination of the processor 1210 and memory 1220 may form processing means 1250 adapted to implement various embodiments of the present disclosure.

The memory 1220 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1220 is shown in the device 1200, there may be several physically distinct memory modules in the device 1200. The processor 1210 may be of any type suitable to the local technical network, and may include one or more of general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

In summary, embodiments of the present disclosure may provide the following solutions.

The present disclosure provides a method of communication, comprises: in accordance with a determination, at a terminal device, that a total number of downlink control information (DCI) sizes configured to monitor a physical downlink control channel (PDCCH) is greater than a predefined number after a plurality of size alignments of a plurality of pairs of DCI formats for single-cell scheduling, performing a first size alignment of a pair of DCI formats for multi-cell scheduling; and monitoring the PDCCH from a network device based on the first size alignment.

In one embodiment, the method as above, the pair of DCI formats for multi-cell scheduling comprises a first DCI format and a second DCI format, and performing the first size alignment comprises: determining, from the first DCI format and the second DCI format, one DCI format with a smaller size, the first DCI format scheduling uplink transmissions on a plurality of cells and the second DCI format scheduling downlink transmissions on the plurality of cells; and generating a number of padding bits for padding the one DCI format with the smaller size to be with a same size as the other one of the first DCI format and the second DCI format.

In one embodiment, the method as above, further comprising: in accordance with a determination that the total number of DCI sizes configured to monitor the PDCCH is greater than the predefined number after the first size alignment, performing a second size alignment between the pair of DCI formats and one of the plurality of pairs of DCI formats.

In one embodiment, the method as above, performing the second size alignment comprises: in accordance with a determination that a first size of the pair of DCI formats is smaller than a second size of the one of the plurality of pairs of DCI formats, generating a number of padding bits for padding the first size of the pair of DCI formats to be with the second size; or in accordance with a determination that the first size is greater than the second size, generating a number of padding bits for padding the second size of the one of the plurality of pairs of DCI formats to be with the first size.

In one embodiment, the method as above, the one of the plurality of pairs of DCI formats comprises DCI formats 0_1 and 1_1.

In one embodiment, the method as above, the pair of DCI formats for multi-cell scheduling comprises DCI formats 0_X and 1_X.

In one embodiment, the method as above, the total number of DCI sizes configured to monitor a PDCCH is greater than a predefined number comprises: the total number of DCI sizes configured to monitor a PDCCH is greater than 4, or the total number of DCI sizes with a cell-radio network temporary identifier (C-RNTI) configured to monitor a PDCCH is greater than 3.

The present disclosure provides a method of communication, comprises: in accordance with a determination, at a terminal device, that a first size of a downlink control information (DCI) format for a first cell is smaller than a second size of the DCI format for a second cell, performing a size alignment of the first size and the second size, the terminal device being configured to monitor the DCI format scheduling a plurality of cells comprising the first cell and the second cell; and monitoring a physical downlink control channel (PDCCH) carrying the DCI format from a network device based on the size alignment.

In one embodiment, the method as above, performing the size alignment comprises: generating a number of padding bits for padding the first size to be the second size.

In one embodiment, the method as above, further comprising: receiving, from the network device, configuration information indicating whether to perform the size alignment among the plurality of cells.

In one embodiment, the method as above, the DCI format is a DCI format 0_X or a DCI format 1_X.

The present disclosure provides a method of communication, comprises: in accordance with a determination, at a terminal device, that a plurality of cells are configured with a same value for determining a starting position of a plurality of physical downlink control channel (PDCCH) candidates, determining a first number of the plurality of cells and a second number of the plurality of PDCCH candidates; determining a number of PDCCH candidates for each of the plurality of cells based on the first number and the second number; and monitoring a PDCCH from a network device based on the number of PDCCH candidates for each of the plurality of cells.

In one embodiment, the method as above, determining a number of PDCCH candidates for each of the plurality of cells comprises: determining the number of PDCCH candidates for each of the plurality of cells being the second number divided by the first number.

In one embodiment, the method as above, further comprising: determining a number of control channel elements (CCEs) for each of the plurality of cells being a third number of CCEs determined based on the value divided by the first number.

In one embodiment, the method as above, the same value for determining the starting position of the plurality of PDCCH candidates is a carrier indicator field value.

The present disclosure provides a method of communication, comprises: in accordance with a determination, at a network device, that a total number of downlink control information (DCI) sizes configured to monitor a physical downlink control channel (PDCCH) is greater than a predefined number after a plurality of size alignments of a plurality of pairs of DCI formats for single-cell scheduling, performing a first size alignment of a pair of DCI formats for multi-cell scheduling; and transmitting, to a terminal device, the PDCCH based on the first size alignment.

In one embodiment, the method as above, the pair of DCI formats for multi-cell scheduling comprises a first DCI format and a second DCI format, and performing the first size alignment comprises: determining, from the first DCI format and the second DCI format, one DCI format with a smaller size, the first DCI format scheduling uplink transmissions on a plurality of cells and the second DCI format scheduling downlink transmissions on the plurality of cells; and generating a number of padding bits for padding the one DCI format with the smaller size to be with a same size as the other one of the first DCI format and the second DCI format.

In one embodiment, the method as above, further comprising: in accordance with a determination that the total number of DCI sizes configured to monitor the PDCCH is greater than the predefined number after the first size alignment, performing a second size alignment between the pair of DCI formats and one of the plurality of pairs of DCI formats.

In one embodiment, the method as above, performing the second size alignment comprises: in accordance with a determination that a first size of the pair of DCI formats is smaller than a second size of the one of the plurality of pairs of DCI formats, generating a number of padding bits for padding the first size of the pair of DCI formats to be with the second size; or in accordance with a determination that the first size is greater than the second size, generating a number of padding bits for padding the second size of the one of the plurality of pairs of DCI formats to be with the first size.

In one embodiment, the method as above, the one of the plurality of pairs of DCI formats comprises DCI formats 0_1 and 1_1.

In one embodiment, the method as above, the pair of DCI formats for multi-cell scheduling comprises DCI formats 0_X and 1_X.

In one embodiment, the method as above, the total number of DCI sizes configured to monitor a PDCCH is greater than a predefined number comprises: the total number of DCI sizes configured to monitor a PDCCH is greater than 4, or the total number of DCI sizes with a cell-radio network temporary identifier (C-RNTI) configured to monitor a PDCCH is greater than 3.

The present disclosure provides a method of communication, comprises: in accordance with a determination, at a network device, that a first size of a downlink control information (DCI) format for a first cell is smaller than a second size of the DCI format for a second cell, performing a size alignment of the first size and the second size; and transmitting, to a terminal device, a physical downlink control channel (PDCCH) carrying the DCI format based on the size alignment, the terminal device being configured to monitor the DCI format scheduling a plurality of cells comprising the first cell and the second cell.

In one embodiment, the method as above, performing the size alignment comprises: generating a number of padding bits for padding the first size to be the second size.

In one embodiment, the method as above, further comprising: transmitting, to the terminal device, configuration information indicating whether to perform the size alignment among the plurality of cells.

In one embodiment, the method as above, the DCI format is a DCI format 0_X or a DCI format 1_X.

The present disclosure provides a method of communication, comprises: in accordance with a determination, at a network device, that a plurality of cells are configured with a same value for determining a starting position of a plurality of physical downlink control channel (PDCCH) candidates, determining a first number of the plurality of cells and a second number of the plurality of PDCCH candidates; determining a number of PDCCH candidates for each of the plurality of cells based on the first number and the second number;

and transmitting, to a terminal device, a PDCCH based on the number of PDCCH candidates for each of the plurality of cells.

In one embodiment, the method as above, determining a number of PDCCH candidates for each of the plurality of cells comprises: determining the number of PDCCH candidates for each of the plurality of cells being the second number divided by the first number.

In one embodiment, the method as above, further comprising: determining a number of control channel elements (CCEs) for each of the plurality of cells being a third number of CCEs determined based on the value divided by the first number.

In one embodiment, the method as above, the same value for determining the starting position of the plurality of PDCCH candidates is a carrier indicator field value.

The present disclosure provides a terminal device, comprising: a processor; and a memory storing computer program codes; the memory and the computer program codes configured to, with the processor, cause the terminal device to perform the method implemented at the terminal device discussed above.

The present disclosure provides a network device, comprising: a processor; and a memory storing computer program codes; the memory and the computer program codes configured to, with the processor, cause the network device to perform the method implemented at the network device discussed above.

The present disclosure provides a computer readable medium having instructions stored thereon, the instructions, when executed by a processor of an apparatus, causing the apparatus to perform the method implemented at a terminal device or a network device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 6-20. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-21. (canceled)

22. A method performed by a terminal device, comprising:
performing a first size alignment of a pair of downlink control information (DCI) formats for multi-cell scheduling, in response to a total number of different downlink control information (DCI) sizes configured to monitor is more than a first number after a plurality of size alignments of a plurality of pairs of DCI formats for single-cell scheduling or a total number of different DCI sizes with cell-Radio Network Temporary Identifier (C-RNTI) configured to monitor is more than a second number after the plurality of size alignments of the plurality of pairs of DCI formats for single-cell scheduling; and
monitoring the DCI formats on physical downlink control channel (PDCCH).

23. The method of claim 22, wherein the plurality of pairs of the DCI formats for single-cell scheduling comprises DCI format 0_1, DCI format 1_1, DCI format 0_2, DCI format 1_2, and the pair of the DCI formats for multi-cell scheduling comprises a first DCI format for scheduling multiple physical uplink shared channels (PUSCHs) in multiple cells and a second DCI format for scheduling multiple physical downlink shared channels (PDSCHs) in multiple cells,
wherein in response to the total number of different DCI sizes configured to monitor is more than the first number after DCI alignments of the DCI formats 0_2, 1_2 and 0_1, 1_1 or the total number of different DCI sizes with C-RNTI configured to monitor is more than the second number after DCI alignments of the DCI formats 0_2, 1_2 and 0_1, 1_1:
based on number of information bits in the first DCI format prior to padding is less than payload size of the second DCI format, a number of zero padding bits are generated for the first DCI format until the payload size equals that of the second DCI format,
based on number of information bits in the second DCI format prior to padding is less than payload size of the first DCI format, zeros shall be appended to the second DCI format until the payload size equals that of the first DCI format.

24. The method of claim 22, wherein the first number is 4, and the second number is 3.

25. A method performed by a network device, comprising:
performing a first size alignment of a pair of downlink control information (DCI) formats for multi-cell scheduling, in response to a total number of different downlink control information (DCI) sizes configured to monitor is more than a first number after a plurality of size alignments of a plurality of pairs of DCI formats for single-cell scheduling or a total number of different DCI sizes with cell-Radio Network Temporary Identifier (C-RNTI) configured to monitor is more than a second number after the plurality of size alignments of the plurality of pairs of DCI formats for single-cell scheduling; and
transmitting the DCI formats on physical downlink control channel (PDCCH).

26. The method of claim 25, wherein the plurality of pairs of the DCI formats for single-cell scheduling comprises DCI format 0_1, DCI format 1_1, DCI format 0_2, DCI format 1_2, and the pair of the DCI formats for multi-cell scheduling comprises a first DCI format for scheduling multiple physical uplink shared channels (PUSCHs) in multiple cells and a second DCI format for scheduling multiple physical downlink shared channels (PDSCHs) in multiple cells,
wherein in response to the total number of different DCI sizes configured to monitor is more than the first number after DCI alignments of the DCI formats 0_2, 1_2 and 0_1, 1_1 or the total number of different DCI sizes with C-RNTI configured to monitor is more than the second number after DCI alignments of the DCI formats 0_2, 1_2 and 0_1, 1_1:
based on number of information bits in the first DCI format prior to padding is less than payload size of the second DCI format, a number of zero padding bits are generated for the first DCI format until the payload size equals that of the second DCI format,
based on number of information bits in the second DCI format prior to padding is less than payload size of the first DCI format, zeros shall be appended to the second DCI format until the payload size equals that of the first DCI format.

27. The method of claim 25, wherein the first number is 4, and the second number is 3.

28. A terminal device, comprising a processor configured to:
perform a first size alignment of a pair of downlink control information (DCI) formats for multi-cell scheduling, in response to a total number of different downlink control information (DCI) sizes configured to monitor is more than a first number after a plurality of size alignments of a plurality of pairs of DCI formats for single-cell scheduling or a total number of different DCI sizes with cell-Radio Network Temporary Identifier (C-RNTI) configured to monitor is more than a second number after the plurality of size alignments of the plurality of pairs of DCI formats for single-cell scheduling; and
monitor the DCI formats on physical downlink control channel (PDCCH).

29. The terminal device of claim 28, wherein the plurality of pairs of the DCI formats for single-cell scheduling comprises DCI format 0_1, DCI format 1_1, DCI format 0_2, DCI format 1_2, and the pair of the DCI formats for multi-cell scheduling comprises a first DCI format for scheduling multiple physical uplink shared channels (PUSCHs) in multiple cells and a second DCI format for scheduling multiple physical downlink shared channels (PDSCHs) in multiple cells,
wherein in response to the total number of different DCI sizes configured to monitor is more than the first number after DCI alignments of the DCI formats 0_2, 1_2 and 0_1, 1_1 or the total number of different DCI sizes with C-RNTI configured to monitor is more than the second number after DCI alignments of the DCI formats 0_2, 1_2 and 0_1, 1_1:
based on number of information bits in the first DCI format prior to padding is less than payload size of the second DCI format, a number of zero padding bits are generated for the first DCI format until the payload size equals that of the second DCI format,
based on number of information bits in the second DCI format prior to padding is less than payload size of the first DCI format, zeros shall be appended to the second DCI format until the payload size equals that of the first DCI format.

30. The terminal device of claim 28, wherein the first number is 4, and the second number is 3.
